(19) United States
(12) Patent Application Publication
(10) Pub. No.: US 2002/0009265 A1
(43) Pub. Date: Jan. 24, 2002

(54) Optical waveguide device

(75) Inventor: Takenori Ichigi, Konan-Shi (JP)

Correspondence Address: BURR & BROWN, PO BOX 7068, SYRACUSE, NY, 13261-7068, US

(73) Assignee: NGK Insulators, Ltd.

(21) Appl. No.: 09/815,961

(22) Filed: Mar. 23, 2001

(30) Foreign Application Priority Data
Mar. 24, 2000 (JP) 2000-84819

(51) Int. Cl. G02B 6/30; G02B 6/42

(52) U.S. Cl. 385/49; 385/50; 385/88

(57) ABSTRACT

An optical waveguide device comprises: a optical waveguide substrate 1 having a optical waveguide 6 provided on a main surface 1a ; ribbon shaped multiple optical fibers and single-core optical fibers 3a, 3 each connected to the optical waveguide substrate 1; and a metallic package 4 for sealing them with air tightness. In this, device, a lower end 5b of a support leg 5 for holding the optical waveguide substrate 1 at an upper end 5a is mounted on the inner surface of the package 4. The support leg 5 has an extension portion 5c that extends the upper end 5a in the longitudinal direction of the ribbon shaped multiple optical fibers fiber 3a relevant to the lower end 5b.

In this manner, there is provided a optical waveguide device capable of more effectively adjusting a difference in an optical fiber and a metal package between expansion and contraction dimensions caused by a thermal expansion difference at the inside of a package sealed with air tightness, and effective to the vibration applied to the optical waveguide device, and smaller sized.

### BACKGROUND OF THE INVENTTION

1. Field of the Invention

The present invention relates to a optical waveguide device comprising: a optical waveguide substrate having a optical waveguide on a main surface of the substrate; ribbon shaped multiple optical fibers and a single optical fiber connected to this optical waveguide substrate; and a metallic package for sealing them hermetically.

2. Description of Related Art

Conventionally, an optical waveguide device utilized in optical fiber communication comprises: an optical waveguide substrate in which a optical waveguide is provided on a main surface of a substrate, made of LiNbO3 (or Lithium Niobate) by thermally diffusing the metal such as Ti, and the optical waveguide consists of a plurality of the straight waveguide and one or more of the Y shaped branch waveguide or the like; ribbon shaped multiple optical fibers and a single optical fiber connected to this optical waveguide substrate at the both end faces of the optical waveguide substrate; and a metallic package to seal them hermetically. wherein ribbon shaped multiple optical fibers and a single optical fiber connected to both end faces of the optical waveguide substrate are secured in the package, and the optical waveguide substrate is supported by only the ribbon shaped multiple optical fibers and a single-core optical fiber.

The package to seal this optical waveguide substrate hermetically is often exposed under severe exterior environment. Specifically it is subjected to from a temperature as high as 85° C. to a temperature as low as −40° C., and is subjected to highly humid environment. Thus, the optical waveguide device must be reliable under such severe environment. Thus, in such optical wavequide device, because an optical fiber and a optical waveguide substrate, made of quartz or optical crystal such as LinbO3 or Si crystal, have the thermal expansion coefficient of 5 to 100×10 ⁻⁷, whereas 200×10−7 for the metallic package. Because of such thermal expansion coefficient, the optical waveguide substrate needs to be mounted in a metallic package with an unique structure. In such structure, the optical waveguide substrate, which is connected with ribbon shaped multiple optical fibers at the one endface and with a single optical fiber at another endface, is mounted in the metallic package indirectly by holding the fibers at the both far-ends of the package with the proper slackness on the fibers. Then, the thermal expansion differences among fibers and an optical waveguide substrate and a package are absorbed by the variation of the fiber slackness.

On the other hand, some optical waveguide devices realize the active functions such as optical intensity modulation. In such devices, the functions are realized by loading the electrical signals on the optical waveguides. In such devices, the optical waveguide substrate equip the thin film metal electrodes on or around the waveguides to load the electrical signals on the optical waveguides, and the metallic packages equip the electrical terminals and the terminals are wire-bonded to the electrodes on the optical waveguide substrates to load the electrical signals from the outside of the packages. However, the bonding wires between the electrodes on the optical waveguides and the electrical package may be broken when the device experience the vibration environment because the optical waveguide substarate is flexibly mounted on the package and can be moved by the vibration. In a package housing such optical waveguide substrate, when a optical waveguide is supported by only an optical fiber as described above, one end of the wire is fixed to the electrode pad of the package and thus no variation of the position relative to the package occurs, but the other end exists on the optical waveguide and thus, slight variation relative to the package can occur. Such state of one end variation and one-end variation generates a stress, in particular, a repetitive stress at a delicate wire, which causes a variety of failures such as cutting off of the wire or release from an electrode.

In order to prevent a failure generated at such wire, when a optical waveguide substrate itself is fixed to a package in order to set another end at which variation occurs to be fixed, a dimensional change caused by thermal expansion difference must be absorbed by a constituent element connecting portion or optical fiber itself in a limited space, i.e., at the inside of a package sealed with air tightness, the package housing members with their large thermal expansion difference as described previously. If no action is taken for weatherability, there has been concern for failure about optical fiber or the like.

Conventionally, there has been provided means for fixing a optical waveguide substrate to a package, and absorbing a dimensional change caused by a thermal expansion difference mainly using flexibility or an optical fiber. That is, in an optical fiber from a one-end package sealing portion to a optical waveguide substrate and an optical fiber from the optical waveguide substrate to the other end package sealing portion, both of the optical fibers are connected to each other in a state they are not cut even in a state in which a dimensional difference is the largest. In a process in which such dimensional difference decreases, the excess of the optical fibers has been absorbed by its slackness.

However, although an optical fiber is flexible, the slackening quantity or range is required to be a permissible radium of curvature. In order to allow such an optical fiber connected to both sides of a optical waveguide substrate to slack, a package is unavoidably large-sized for a slackening space. In addition, a connection portion between an optical fiber and a optical waveguide substrate is designed in consideration of shear force caused by slackness. In particular, a connection portion between a ribbon shaped multiple optical fibers fiber and a optical waveguide substrate is subjected to resilient force obtained by multiplying the number of cores when a fiber is slackened. Thus, design must be made in consideration of high strength as compared with a connection portion at the single core side, which causes a package to be large-sized.

Therefore, while all devices are required to be small-sized, only the package is unavoidably large sized in order to ensure wheatherability. There has been a growing demand for a small-sized package with its weatherability.

### SUMMARY OF THE INVENTION

It is an object of the present invention to provide a optical waveguide device smaller than a conventional optical waveguide devices in which a elongation difference between an optical fiber and a metal package caused by a thermal expansion difference inside of a package sealed hermetically can be adjusted more effectively, the optical waveguide device being more reliable to the vibration applied to the optical waveguide device.

According to the present invention, there is provided an optical waveguide device comprising:

a optical waveguide substrate having a optical waveguide on a main sursurface of the substrate;

ribbon shaped multiple optical fibers and a single optical fiber connected to this optical waveguide substrate; and

a metallic package for sealing them hermetically;

a support leg for mounting the optical waveguide substrate on the metallic package, wherein a top end of the supprot leg is holding the optical waveguide substrate, and the center portion of the support leg has the extended shape parallel to the optical path direction of the ribbon shaped multiple optical fibers, and the bottom end of the support leg is mounted on the inner surface of the metallic package.

In this manner, even if thermal expansion occurs with an optical waveguide device exposed under severe environment, an elongation of a metallic package from the bottom end position of a support leg, at which the support leg is mounted on the package, to a position at which ribbon shaped multiple optical fibers is fixedly sealed in a package is primarily offset by an extension portion at the center of the support leg being extended by a thermal expansion equal to that of a metal package. Thus, any stress is not substantially generated at a connectiong portion between the ribbon shaped multiple optical fibers and the optical waveguide substrate. On the other hand, an extension of a metal package from the bottom end position of the support leg to the position at which a single fiber is fixedly sealed in the package is absorbed by decreasing the slackness of the single fiber.

In contrast, in the case where thermal shrinkage occurs due to the lowering of an environment temperature, a shrink of a metal package from the lower end position of the support leg to a position at which ribbon shaped multiple optical fibers is fixedly sealed in the package is primarily offset by an extension portion at the center of the support leg being contracted by a thermal shrinkage equal to the metal package. In this case as well, any stress is not generated at a connectiong portion of a optical waveguide substrate. On the other hand, a shrink of a metal package from the bottom end portion of the support leg to a position at which a single fiber is fixedly sealed in the package is absorbed by increasing the slackness of the single fiber. Here, a shear stress is generated at a connectiong portion between a fiber and a substrate due to the slackness of the fiber. However, the shear stress is much weaker than the the stress being caused by the same slackness of the ribbon shaped multiple optical fibers.

In addition, in the case where two or more support legs are present, it is desirable that a spacer plate, in which the thermal expansion ratio is equal to the optical waveguide substrate, is provided on the top end surface of the plurality of support legs, and an optical waveguide substrate is mounted on the top surface of the spacer plate, thereby interposing a spacer plate between the support legs and the optical waveguide substrate. In this manner, the shear stress on the optical waveguide substrate, which is caused by the dimensional mismatch between the thermal expansion of the substrate and the positional shift of the plurality of the top end of the support legs, is canceled in the spacer plate. Thus, the distortion by the shear stress in the optical waveguide substrate dose not occur, and a optical signal degradation by the distortion dose not occur. This spacer plate is very effective when the optical waveguide substrate is made of the materials, in which the optical refractive index is sensitive for the stress, such as the InP based semiconductor waveguide chip; a dielectric (glass) waveguide chip employing a glass substrate; or strong dielectric crystal waveguide chip composed of LiNbO₃ crystal or the like.

Preferably an extension portion at the center of the support leg is made of a material with its thermal expansion coefficient higher than that of a package, the material being easily processed. For example, an engineering plastics or metal is suitable. If the extension portion is sufficiently longer in the longitudinal direction of the ribbon shaped multiple optical fibers than the size of the size of the top and bottom ends of the support leg, the top and bottom ends can be made of different materials which has appropreate adhesive of bonding properties. In addition, the bottom end of the support leg to can be mounted on the bottom or side of the inner surface of the package. Further, the support leg may have a gap as large as the hight of the bottom end of the support leg, between the bottom surface of the extension portion and the inner surface of the package on which the end of the support leg is mounted. In contrast, the bottom end of the support leg may be eliminated, and the suport leg is mounted on the package by the limited area in the bottom surface of the extension portion at the nearest edge to the single optical fiber. Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principle of the present invention.

FIG. 1 is an illustrative view of a optical waveguide device according to the present invention; and

FIG. 2 is an illustrating view of a optical waveguide device according to another embodiment of the present invention.

### DETAILED DESCRIPTION OF THE EMBODIMENT

Reference will now be made in detail to the presently preferred embodiments of the invention as illustrated in the accompanying drawings, in which like reference numerals designate line or corresponding parts.

Hereinafter, preferred embodiments of the present invention will be described with reference to the accompanying drawings.

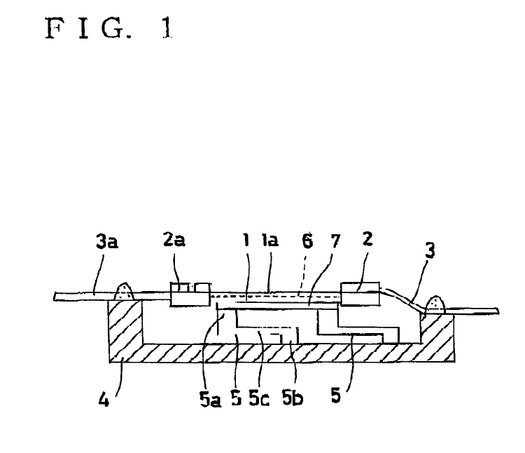

FIG. 1 schematically illustrates a optical waveguide device consists of a optical waveguide substrate 1; and an optical fiber array, which consists of V groove substrates 2 and 2a, a single-core fiber 3 and a ribbon-shaped fiber 3a; a metallic package 4; and a support leg 5 holding the optical waveguide substrate. A optical waveguide 6 is formed on a main surface 1a of the substrate 1 which is made of LiNbO₃ or LiTaO₃. This optical waveguide 6 consists of the straight waveguide, which starts at an endface of the substrate and connects to a Y shaped branch portion, and a Y shaped branch portion, and a pair of straight portion which connect to another endface of the substrate in serial. And a pair of electrodes are deposited on or around the Y shaped branch portion to realize a optical signal modulation by applying the proper voltage.

Furthermore, various functions can be realized by cascading straight portions and the plurality of the Y shaped branch portions in the tree structure and depositing the electrodes on or around each Y shaped branch. The single optical fiber 3 and the ribbons shaped multiple optical fibers 3a mounted to the V-groove substrates 2 and 2a are inserted through a metallic package 4, and are connected to the outside.

A support leg 5 holds the optical waveguide substrate 1 at the top end 5a with the back side surface of the substrate 1, and a bottom end 5b of the support leg 5 is mounted on the inner bottom surface of package 4. An extension portion 5c, which locates between the top end 5a and bottom end 5b of the support leg 5, is extended from the bottom end 5b upto the top end 5a in parallel to the longitudinal direction of the ribbon shaped multiple optical fibers 3a. The thermal expansion of the ribbon shaped multiple fibers 3a from the hermetically sealed position on the package 4 to the connecting position to the optical wavequide substrate 1 is relatively smaller than the expansion of the package 4 from the sealed position with the fibers 3a to the connecting position of the fibers 3a to the optical waveguide substrate 1, however, the expansion difference between the fibers 3a and the package 4 is cancelled by the large thermal expansion of the extension portion of the support leg 5c. Furthermore, the optical waveguide substrate 1 is mounted on the package 4 by the support leg 5. Thus, even if the optical waveguide device itself is vibrated in the vertical and transverse directions, as in the conventional manner, optical fiber disconnection or release and/or disconnection of a bonding wire (not shown) can be prevented.

In addition, a spacer plate 7, in which the thermal expansion is equal to the optical waveguide substrate 1 made of LiNbO3 or LiTaO3, is interposed between the optical waveguide substrate 1 and two support legs 5. Thus, a shear stress, which is caused by the dimensional mismatch between the thermal expansion of the substrate 1 and the positional shift of the top ends of two support legs 5a, is canceled in the spacer plate 7.

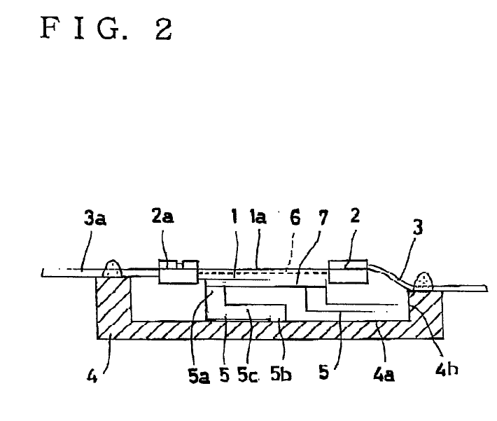

FIG. 2 shows another embodiment of the present invention, wherein the extension portion 5c can be mounted on the bottom surface 4a of the package 4 by a limited area 5b in the bottom surface of the support leg 5, and another support leg 5 can be mounted on the side surface 4b.

According to the present invention, there dan be provided an optical waveguide device capable of more effectively adjusting the dimensional mismatch occurred by the thermal expansion among the optical fibers and a optical waveguide substrate and a metallic package, and effective to the vibration applied to the optical waveguide device, and smaller sized.

Additional advantages and modifications will readily occur to those skilled in the art. Therefore, the invention in its broader aspect is not limited to the specific details and representative embodiments shown and described herein. Accordingly, various modifications may be made without departing from the spirit or scope of the general inventive concept as defined by the appended claims and their equivalents.

What is claimed is:

1. An optical waveguide device comprising:
a optical waveguide substrate having a optical waveguide on a main surface of the substrate;
ribbon shaped multiple optical fibers and a single optical fiber connected to this optical waveguide substrate; and
a metallic package for sealing them hermetically;
a support leg for mounting the optical waveguide substrate on the metallic package, wherein a top end of the supprot leg is holding the optical waveguide substrate, and the center portion of the support leg has the extended shape parallel to the optical path direction of the ribbon shaped multiple optical fibers, and the bottom end of the support leg is mounted on the inner surface of the metallic package.

2. A optical waveguide device wherein the support leg as claimed in claim 1 is provided in plurality, a spacer plate is provided on an top end surface of the plurality of support legs, and a optical waveguide substrate is mounted on an top surface of the spacer plate.
